(19) United States
(12) Patent Application Publication
(10) Pub. No.: US 2006/0222258 A1
(43) Pub. Date: Oct. 5, 2006

(54) Image restoration with gain control and shoot suppression

(75) Inventors: Surapong Lertrattanapanich, Santa Ana, CA (US); Yeong-Taeg Kim, Irvine, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/099,711

(22) Filed: Apr. 5, 2005

(51) Int. Cl. G06K 9/40

(52) U.S. Cl. 382/254

(57) ABSTRACT

A image restoration process using gain control and shoot suppression is provided. For each sample of the input observed image, a restored sample is determined by image restoration. Further, a shoot suppression coefficient is calculated by a shoot detector. A global gain is multiplied to a detail component, wherein the detail component is calculated by subtracting the input sample from the restored sample. The result of the calculation is multiplied by the shoot suppression coefficient to obtain globally and locally controlled detail component, which is added back to the input sample wherein the result is a restored sample with gain control and shoot suppression.

### FIELD OF THE INVENTION

The present invention relates to the field of image processing, and more particularly to an image restoration with gain control and shoot suppression.

### BACKGROUND OF THE INVENTION

In digital image processing applications, image restoration is usually used for restoring an original image from a blurred and noisy observed image where prior knowledge of the system point spread function (PSF) or blurring function is available. However, two most prevalent shortcomings of conventional image restoration techniques are introduction of ringing around edges (ringing artifact) and amplified noise, causing false texturing in the flat regions (noise amplification), into restored images. To obtain better understanding of such artifacts, consider a linear shift invariant (LSI) image acquisition process, wherein the degraded observed image g(x,y) is acquired by passing the original image ƒ(x,y) to the blurring operator H and adding the additive noise ν(x,y), as:
g(x,y)=H[ƒ(x,y)]+ν(x,y). (1)

A restored image r(x,y) can be obtained by applying the restore operator G directly to the observed image g(x,y), as:

$$\begin{matrix}r ( x , y ) = G [ g ( x , y ) ] = G [ H [ f ( x , y ) ] + v ( x , y ) ] \\ = f ( x , y ) + ( GH - I ) [ f ( x , y ) ] + G [ v ( x , y ) ] \\ = f ( x , y ) + {e}_{r} ( x , y ) + {e}_{n} ( x , y ) .\end{matrix} \qquad ( 2 )$$

It can be seen from relation (2) that the restored image r(x,y) is equal to the original image ƒ(x,y) with additions of two error terms due to ringing effect eᵣ(x,y) and noise effect eₙ(x,y). The trade off between these two errors is the crucial issue in regularized image restoration and has been analyzed in many studies. Some literatures provide a method of choosing the proper regularization parameter γ in the image restoration.

Generally speaking, the effects of the regularization parameter γ in image restoration to the noise and ringing artifacts are as follows. As the value of γ becomes small (underregularized), the restored operator G is close to the inverse operator of the blurring operator H. Therefore, the operator (GH-I) in the ringing error term is close to the null operator and makes the ringing error eᵣ(x,y) small. However, since blurring operator H in general is a lowpass filter, the restored operator G (which is close to inverse of H) becomes a highpass filter. Then, the high frequency components of the noise ν(x,y) are amplified which makes the error term eₙ(x,y)=G[ν(x,y)] dominate the solution. On the other hand, when the value of γ is large (overregularized), the noise error eₙ(x,y) becomes smaller since the smoothness constraint in the regularized image restoration is imposed. However, the restored operator G becomes very different from the inverse operator of H and leads to the ringing artifact in the restored image.

### BRIEF SUMMARY OF THE INVENTION

The present invention addresses the above shortcomings. An object of the present invention is to provide a method of both controlling the level of image enhancement and suppressing the shoots around edges as well as noise amplification in flat regions of the restored image from an observed image in an image restoration process. A method of globally controlling the level of image enhancement and locally suppressing the over/under shoots around the edges as well as noise amplification in the flat regions of restored image in an image restoration process, is provided.

An embodiment of an image restoration process using gain control and shoot suppression according to the present invention comprises the steps of: (a) for each sample of the input observed image, a restored sample is determined by image restoration; (b) a shoot suppression coefficient is calculated by a shoot detector; (c) a global gain is multiplied to a detail component, wherein the detail component is calculated by subtracting the input sample from the restored sample; (d) the result of the calculation is multiplied by the shoot suppression coefficient to obtain globally and locally controlled detail component, which is added back to the input sample wherein the result is a restored sample gain control and shoot suppression.

Other features and advantages of the present invention will be apparent from the following specifications taken in conjunction with the following drawings.

### BRIEF DESCRIPTION OF THE DRAWINGS

FIG. 1 shows a block diagram of an embodiment of an image restoration system with gain control and shoot suppression according to the present invention.

FIG. 2 shows a block diagram of an embodiment of the image restoration module of FIG. 1.

FIG. 3 shows a block diagram of an embodiment of the shoot suppression module of FIG. 1.

### DETAILED DESCRIPTION OF THE INVENTION

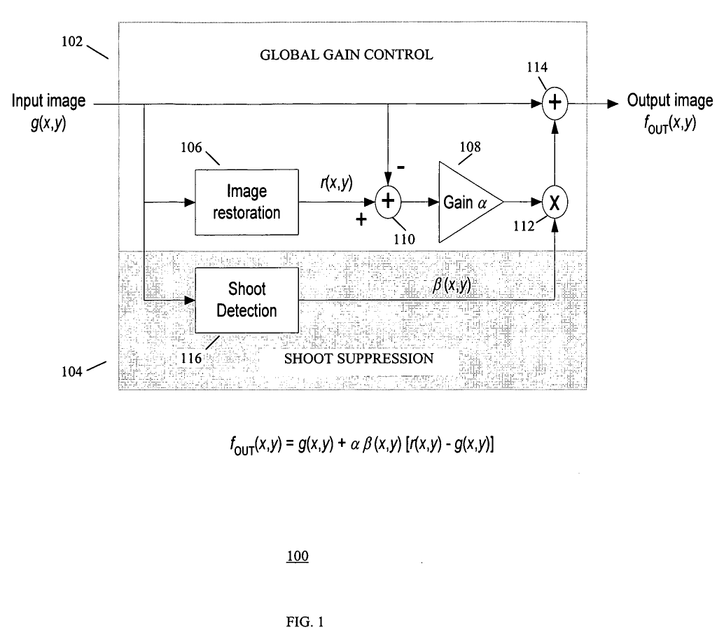

Preferred embodiments of the present invention are described below in more detail with reference to the accompanying drawings. FIG. 1 shows a block diagram of an embodiment of an image restoration system with gain control and shoot suppression according to the present invention. The system 100 comprises two independent modules: (1) a global gain control module 102, and (2) shoot suppression module 104. Each module is explained separately below.

Global Gain Control Module

The global gain control module 102 in the system 100 comprises an image restoration block 106 and a gain control, wherein the gain α is used to globally control the level of image enhancement in image restoration. Further, a shoot suppression coefficient β(x,y) (described further below) is used as an additional control (besides the gain α) for locally suppressing the over/under shoots around edges as well as noise amplification in the flat region in the global gain control module 102.

The restored image output r(x,y) of the image restoration block 106 is obtained by applying image restoration to the input image g(x,y). Then, a difference r(x,y)−g(x,y) is determined by subtracting the input image g(x,y) from the resulting restored image r(x,y) in an adder junction 110. The difference value fundamentally represents the “detail”, or high frequency component, of the input image. Next, the difference value is multiplied by a constant gain α≧0 by the multiplier 112. Finally, the multiplication result is added back to the input image g(x,y) by an adder junction 114 to generate output image ƒ_{OUT}(x,y), as:
ƒ_{OUT}(x,y)=g(x,y)+α[r(x,y)−g(x,y)]. (3)

It is noted that the gain α is primarily used to control the level of image enhancement to the input image. Specifically, the resulting output image ƒ_{OUT}(x,y) can be viewed as the summation of the input image and gain controlled detail (high frequency) component. By adjusting the gain α in relation (3), the output image can represent many interesting cases. For example, for α=0, the second term (controlled detail component) in relation (3) becomes zero and ƒ_{OUT}(x,y)=g(x,y). For α=1, the output image ƒ_{OUT}(x,y) equals the restored image r(x,y). In cases where 0<α<1 and α>1, the levels of enhancements in output image ƒ_{OUT}(x,y) are, respectively, less and more contributed from the detail component.

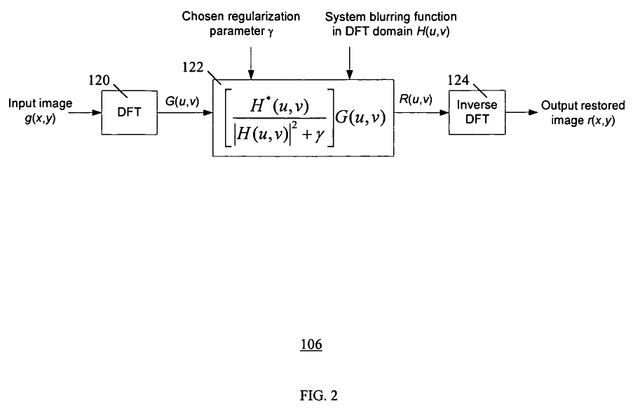

FIG. 2 shows a block diagram of an embodiment of the image restoration module 106 of FIG. 1. Referring to FIG. 2, the input image g(x,y) is transformed into the discrete Fourier transform (DFT) domain to obtain G(u,v) by a DFT module 120. Then, based on the knowledge of the system blurring function in DFT domain H(u,v) and the chosen regularization parameter γ, the DFT domain of the restored image R(u,v) is calculated by a processing module 122 which implements:

$$R ( u , v ) = [ \frac{{H}^{*} ( u , v )}{{\vert H ( u , v ) \vert}^{2} + γ} ] G ( u , v ) ,$$

wherein the superscript * denotes the complex conjugate operator. Finally, the spatial domain of the restored image r(x,y) is obtained by taking the inverse DFT of R(u,v) in an Inverse DFT module 124.
   Shoot Suppression Module

Because in general the restored image r(x,y) may contain overshoot/undershoot (ringing) artifact around the edge areas, the shoot suppression module 104 in the system 100 of FIG. 1 is provided to reduce ringing. The shoot suppression module 104 implements a shoot detection process 116 whose input and output are the input image g(x,y) and shoot suppression coefficient β(x,y), respectively. Besides the global gain α, the shoot coefficient β(x,y) is used in the global gain control module 102 as an additional control to the detail component, as discussed. The output image ƒ_{OUT}(x,y) contributed by both global gain control module 102 and the shoot suppression module 104 can be expressed as
ƒ_{OUT}(x,y)=g(x,y)+αβ(x,y)[r(x,y)−g(x,y)]. (4)

Typically, the shoot suppression coefficient β(x,y) varies from 0 to 1 depending on the degree of shooting effect and noise amplification at an arbitrary coordinate (x,y). Generally: (1) if the coordinate (x,y) is near the edge (sharp transition) area in the input image, it tends to suffer significantly from ringing effect, or (2) if the coordinate (x,y) is among the flat region of the input image, it tends to contain an amplified noise in the restored image, then the appropriate shoot suppression coefficient β(x,y) should be close to zero. Otherwise, the shoot suppression coefficient β(x,y) of those coordinates not classified as the ringing or noise artifact should be close to one.

An example of the shoot detection process 116 implemented in the shoot suppression module 104 according to the present invention is now provided. Let S denote the set of integer numbers which represents neighbor indices with respect to the considered (selected) coordinate (x,y). Three gradient sets d_{R}(x,y;S), d_{L}(x,y;S), and d_{LR}(x,y;S) are defined as:

$$\begin{matrix}{d}_{R} ( x , y ; S ) = \{ {d}_{R} ( i ) = \frac{1}{3} {\sum }_{j = - 1}^{1} \vert g ( x , y ) - g ( x + i , y - j ) \vert \text{:} i ∈ S \} , & ( 5 ) \\ {d}_{L} ( x , y ; S ) = \{ {d}_{L} ( i ) = \frac{1}{3} {\sum }_{j = - 1}^{1} \vert g ( x , y ) - g ( x - i , y - j ) \vert \text{:} i ∈ S \} , & ( 6 ) \\ {d}_{LR} ( x , y ; S ) = \{ {d}_{LR} ( i ) = \frac{1}{2} [ {d}_{L} ( i ) + {d}_{R} ( i ) ] \text{:} i ∈ S \} . & ( 7 )\end{matrix}$$

The three gradient sets in relations (5), (6), and (7) contain the horizontal gradient estimates according to the set S at the coordinate (x,y) of the input image to the left, right, and both sides of the sample at coordinate (x,y), respectively. Next, scalar coefficients τ(x,y;S) and κ(x,y;S) are defined as:

$$\begin{matrix}τ ( x , y ; S ) = \{ \begin{matrix}\frac{avg \{ {d}_{R} ( x , y ; S ) \}}{⌊ max \{ {d}_{L} ( x , y ; S ) \} ⌋ + ɛ} & if ⌊ max \{ {d}_{L} ( x , y ; S ) \} ⌋ > ⌊ max \{ {d}_{R} ( x , y ; S ) \} ⌋ ; \\ \frac{avg \{ {d}_{L} ( x , y ; S ) \}}{⌊ max \{ {d}_{R} ( x , y ; S ) \} ⌋ + ɛ} & otherwise ,\end{matrix} & ( 8 ) \\ κ ( x , y ; S ) = min \{ 1 , {[ \frac{avg \{ {d}_{LR} ( x , y ; S ) \}}{16} ]}^{2} \} , & ( 9 )\end{matrix}$$

wherein ε is a small positive real scalar representing machine precision used in stabilizing the calculation in relation (8); the functions min{a}, max{a}, and avg{a} provide the minimum, maximum, and average of elements in the set a, respectively; and the value └b┘ is the floor of scalar b which is equivalent to the integer part of the scalar b (e.g., └3.14159 ┘=3) . The coefficients τ(x,y;S) and κ(x,y;S) in relations (8) and (9) are inverse proportional to the values representing the degrees of sharp transition (shoot area) and slow transition (flat area) in the input image at location (x,y). The resulting shoot suppression coefficient β(x,y) from the shoot detection process 116 in FIG. 1 is calculated as the minimum between 1.0 and the product of three coefficients τ(x,y,S₁), τ(x,y,S₂), and κ(x,y,S₃) as:
   β(x,y)=min{1.0,τ(x,y,S₁)τ(x,y,S₂)κ(x,y,S₃)}, (10)
where the sets S₁={1}, S₂={1, 2, 3, 4, 5}, and S₃={1, 2, 3}.

The detail component r(x,y)−g(x,y) used to enhance the detail of the input image is controlled both globally by the gain a and locally by the shoot suppression coefficient β(x,y). Therefore, the output image ƒ_{OUT}(x,y) possesses greater detail when compared to the input mage g(x,y) without suffering from ringing artifact around the edges and noise amplification in the flat regions.

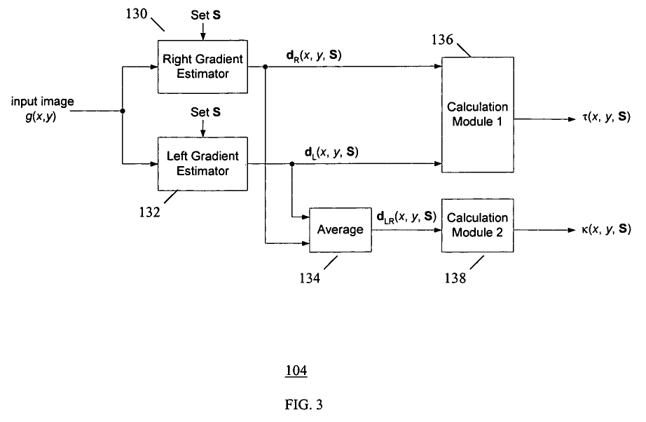

FIG. 3 shows a block diagram of an embodiment of the shoot suppression module 104 of FIG. 1 and as described above. Referring to FIG. 3, based on the chosen sets of integer numbers representing neighbor indices, the sets of right gradients d_{R}(x,y,S) and left gradients d_{L}(x,y,S) are calculated by a Right Gradient Estimator 130 and a Left Gradient Estimator 132 according to relations (5) and (6), respectively. Then, the average element-by-element of both d_{R}(x,y,S) and d_{L}(x,y,S) is determined by an averaging module 134, resulting in the average gradient d_{LR}(x,y,S). Two scalar coefficients τ(x,y;S) and κ(x,y;S) are obtained by using a first calculation module 136 and a second calculation module 138 implementing (8) and (9), respectively.

Thereafter, the shoot suppression coefficient according to an embodiment the present invention is obtained by determining the minimum between 1.0 and the product of three scalar coefficients τ(x,y,S₁), τ(x,y,S₂), and κ(x,y,S₃), where sets S₁={1}, S₂={1, 2, 3, 4, 5}, and S₃={1, 2, 3}, according to relation (10) above.

The shoot suppression module 104 reduces ringing and the gain control module 106 globally controls the level of image enhancement in image restoration. With these two modules 104 and 106, in one aspect the present invention provides global control of the level of image enhancement and, at the same time, local suppression of the shoots (ringing) around the edges as well as noise amplification in the flat regions of restored image in image restoration process.

The present invention has been described in considerable detail with reference to certain preferred versions thereof; however, other versions are possible. Therefore, the spirit and scope of the appended claims should not be limited to the description of the preferred versions contained herein.

What is claimed is:

1. A method of restoring an original image from an observed input image, comprising the steps of:
generating a restored image from the observed image;
generating a gain controlled image as a function of the restored image and the input image;
determining a shoot suppression coefficient for the input image; and
generating a final restored image as a function of the gain controlled image, the input image and the shoot suppression coefficient.

2. The method of claim 1, wherein the step of generating a gain controlled image further includes the steps of:
determining a difference between the input image and the restored image; and
performing gain control on the difference to obtain the gain controlled image.

3. The method of claim 1, wherein the step of generating a final restored image further includes the steps of:
applying the shoot suppression coefficient to the gain controlled image to generate a shoot-suppressed image; and
adding the input image to the shoot-suppressed image to generate the final restored image.

4. A method of restoring an original image from an observed input image, comprising the steps of:
performing image restoration on the input image to obtain a first intermediate restored image;
determining a difference between the input image and the first intermediate restored image;
performing gain control on the difference to obtain a gain controlled difference;
determining a shoot suppression coefficient for the input image;
applying the shoot suppression coefficient to the gain controlled difference to obtain a second intermediate restored image; and
combining the input image with the second intermediate restored image to obtain a final restored image as output.

5. An image restoration method for restoring an original image from an observed input image, comprising the steps of:
for each sample of the input image, determining a restored sample by image restoration;
determining an image detail component by subtracting the input sample from the restored sample;
applying a global gain to the image detail component to obtain a gain-controlled image detail component;
determining a shoot suppression coefficient for the input image;
applying the shoot suppression coefficient to the gain-controlled image detail component to generate a globally and locally controlled detail component; and
adding the globally and locally controlled detail component to the input sample wherein to generate a restored sample output with gain control and shoot suppression.

6. An image restoration method for restoring an original image from an observed input image, comprising the steps of:
for each sample of input image g(x,y) at coordinate (x, y), determining a restored sample r(x,y) using an image restoration process;
determining a detail component as r(x,y)−g(x,y), and applying a global gain α to r(x,y)−g(x,y) to obtain a gain controlled detail component as α[r(x,y)−g(x,y)];
multiplying the gain controlled detail component α[r(x,y)−g(x,y)] by a shoot suppression coefficient β(x,y) to obtain a globally and locally controlled detail component as: αβ(x,y)[r(x,y)−g(x,y)]; and
adding the globally and locally controlled detail component αβ(x,y)[r(x,y)−g(x,y)] to the input sample g(x,y) to generate a final restored image output ƒ_{OUT}(x,y) as:
ƒ_{OUT}(x,y)=g(x,y)+αβ(x,y)[r(x,y)−g(x,y)].

7. The method of claim 6 further comprising the steps of determining the shoot suppression coefficient β(x,y) by applying shoot detection to the input image.

8. The method of claim 7 wherein the step of determining the shoot suppression coefficient β(x,y) further includes the steps of determining:
β(x,y)=min{1.0, τ(x,y,S₁)τ(x,y,S₂)κ(x,y,S₃)},
where the sets S₁={1}, S₂={1, 2, 3, 4, 5}, and S₃={1, 2, 3}; and
τ(x,y;S) and κ(x,y;S) are scalar coefficients.

9. An image restoration system for restoring an original image from an observed input image, comprising:
a shoot suppression module that provides a shoot suppression coefficient from the input image; and
a gain control module that uses a global gain factor and the shoot suppression coefficient to globally control the level of image enhancement in generating a restored output image from input image.

10. The system of claim 9, wherein the gain control module further comprises:
an image restorer that for each sample of the input image, determines a restored sample by image restoration;
a differencing means that determines an image detail component by subtracting the input sample from the restored sample;
a gain controller that applies the global gain factor to the image detail component to obtain a gain-controlled image detail component;
means for applying the shoot suppression coefficient to the gain-controlled image detail component to generate a globally and locally controlled detail component; and
means for adding the globally and locally controlled detail component to the input sample wherein to generate a restored sample output with gain control and shoot suppression.

11. An image restoration system for restoring an original image from an observed input image, comprising:
a shoot suppression module that provides a shoot suppression coefficient β(x,y) from an input image sample g(x,y); and
a gain control module that uses a global gain factor and the shoot suppression coefficient to globally control the level of image enhancement in generating a restored output image from input image, the gain control module comprising:
an image restorer that for each sample of input image g(x,y) at coordinate (x,y), determining a restored sample r(x,y) using an image restoration process;
a difference means that determines a detail component as r(x,y)−g(x,y), and applying a global gain α to r(x,y)−g(x,y) to obtain a gain controlled detail component as α[r(x,y)−g(x,y)];
a multiplier that multiplies the gain controlled detail component α[r(x,y)−g(x,y)] by the shoot suppression coefficient β(x,y) to obtain a globally and locally controlled detail component as: αβ(x,y)[r(x,y)−g(x,y)]; and
an adder that adds the globally and locally controlled detail component αβ(x,y)[r(x,y)−g(x,y)] to the input sample g(x,y) to generate a final restored image output ƒ_{OUT}(x,y) as:
ƒ_{OUT}(x,y)=g(x,y)+αβ(x,y)[r(x,y)−g(x,y)].

12. The system of claim 11 wherein the shoot suppression module determines the shoot suppression coefficient β(x,y) by applying shoot detection to the input image.

13. The system of claim 11 the shoot suppression module determines the shoot suppression coefficient β(x,y) by determining:
β(x,y)=min{1.0, τ(x,y,S₁)τ(x,y,S₂)κ(x,y,S₃)},
where the sets S₁={1}, S₂={1, 2, 3, 4, 5}, and S₃={1, 2, 3}; and
τ(x,y;S) and κ(x,y;S) are scalar coefficients.
